(19) United States
(12) Patent Application Publication
(10) Pub. No.: US 2007/0060667 A1
(43) Pub. Date: Mar. 15, 2007

(54) Process for preparing pigment concentrates for use in radiation-curable coatings

(76) Inventors: Tunja Jung, Rheinfelden-Herten (DE); Thomas Healy, Renfrewshire (GB); Andre Fuchs, Schliengen-Obereggenen (DE); Thomas Bolle, Efringen-Kirchen (DE)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/557,227

(22) PCT Filed: May 24, 2004
(86) PCT No.: PCT/EP04/50894

§ 371 Date: Nov. 17, 2005

(30) Foreign Application Priority Data
Mar. 3, 2003 (EP) 03405397.5

(51) Int. Cl. C08K 5/00; C09D 11/00

(52) U.S. Cl. 523/125; 106/31.6

(57) ABSTRACT

A process for preparing pigment concentrates is provided which comprises dispersing a dry pigment in a radiation polymerizable (curable) ethylenically-unsaturated compound. The concentrates to which optionally photoinitiators are added can be used for preparing radiation, preferably ultraviolet radiation, curable printing inks, paints or other coating compositions which in turn are applied in printing processes or in the painting or coating of substrates. The performance enhancement of the cured pigmented inks/paints/coatings include e.g. good tinctorial strength and gloss, as well as surface hardness, good adhesion to substrate and chemical and corrosion resistance.

The present invention relates to a process for the production of highly dispersed pigment concentrates to be used for making radiation-curable coatings, including inks or paints, from dry pigment granules and powders

Methods are known for formulating pigment concentrates by the so-called flush process. In this process such compositions would be produced from water-containing pigmented feedstocks of 3-40% pigment content, the underlying principle being that an organic pigment has a greater affinity for an oil phase than an aqueous phase and so transfers or flushes from the aqueous environment to a carrier.

The flush process features and the equipment used have been the subject of much investigation which has resulted in many disclosures of various improvements in the basic concept (e.g. Pigment Handbook, Vol 111, (1973) p 447-455, Editor T. C. Patton).

The basic principle behind the use of, e.g. press-cakes in the flush process, is the direct transfer of pigments in an aqueous phase (press cake) to an oily or non-aqueous phase without intermediate drying.

In the flush procedure the equipment traditionally used is high energy mixers or kneaders, e.g. Sigma-blade kneaders. During the process the aqueous phase is removed by decantation and further, e.g. press-cake and carrier added whereupon the process repeated until the desired flush concentrate is achieved.

The flush process from wet pigment presscake has been extended to the manufacture of concentrates for radiation curing inks (U.S. Pat. No. 6,316,517).

While the use of such flushing techniques avoids certain problems e.g. hydrophilic aggregation on drying, grinding treatment and dusting associated with conventional dry pigment production and use, flushing processes are not without disadvantages e.g.

1. Standardisation of final coloured concentrate due to the use of non-standardised press-cake.

2. The pigment performance when held in presscake form varies with time and conditions of storage.

3. Energy costs associated with effluent treatment of the discarded aqueous phase which also may contain oils.

4. Energy costs not only for the kneading process but also for the drying of the flush to remove all water.

5. The total cycle times are relatively long to produce the final coloured coating agent e.g. printing ink typically 6-18 hours.

6. The use of agents to promote the flushing process e.g. surfactants.

7. Press-cakes of organic pigments are liable to microbiological attack and though it is possible to add biocides/fungicides, the presence of these may be undesirable in inks and paints.

Surprisingly, a process has now been found which overcomes these disadvantages and introduces other advantages.

The process of the present invention was developed to overcome the irreversible aggregation/agglomeration which organic pigments undergo during the drying process of manufacture resulting in pigment preparations which give undesirable applicational results as described in, e.g. U.S. Pat. No. 4,601,759 or EP 273'236.

Accordingly, it is the main object of the present invention to provide a process for preparing a pigment concentrate for use in radiation-curable coatings which comprises dispersing a dry pigment in a radiation (UV/electron beam) curable composition.

Other objects of the present invention relate to said dry pigment concentrates as well as to methods of using them.

The key to this invention is the use of a dry pigment, e.g. in form of granules or powder instead of water-containing pigmented feed-stocks (thus avoiding the flush procedure) in an organic radiation curable vehicle under high shear conditions. Indeed using high shear equipment as for flushing, dry granular or powder products as described herein are very rapidly and highly dispersed producing final inks and paints of excellent properties

Thus the herein defined dry products result in highly dispersed concentrates via processes currently used with water containing pigment compositions, e.g. pigmented press-cakes but with significant advantages over the conventional flush process viz.

(a) The granular or powder products are more easily metered making dosing easier and more accurate.

(b) Since the granular products are dried during the manufacture then no aqueous waste treatment is required.

(c) Processing times are significantly reduced due to the rapid rate of dispersion of the granules or powder.

(d) Energy consumption is reduced since the drying step of the flush process is removed.

(e) Batch sizes are increased by use of the dry pigmented granules.

(f) The granules or powder are standardised prior to use as part of their manufacturing process.

(g) Since press-cakes of organic pigments are liable to biological attack resulting in deterioration of applicational performance in terms of colouristics then this is overcome by the use of the dry standardised granules.

(h) No flush enhancing additives are required.

There are, in particular, significantly reduced processing costs for batch operations, i.e. cycle time (machine time), is between 1-4 hrs, preferably between 1-2 hrs, depending on the pigment used compared to the 5-16 hours cycle time using the traditional flush process.

Alternatively the process may be made continuous in for example a twin screw extruder whereby the difficulties in dewatering the concentrate made from presscake are overcome by the use of dry granules or powder.

The pigments used in this process are based on conventional organic pigments including monoazo, disazo, azomethine, azocondensation, metal-complex azo/azomethine, naphthol, metal (copper) phthalocyanines, dioxazine, nitro, perinone, quinoline, anthraquinone, hydroxyanthraquinone, aminoanthraquinone, benzimidazolone, isoindoline, isoindolinone, quinacridone, anthrapyrymidine, indanthrone, flavanthrone, pyranthrone, anthanthrone, isoviolanthrone, diketopyrrolopyrrole, carbazole, perylene, indigo or thioindigo pigments. Mixtures of pigments may also be used.

Preferred are monoazo, disazo, azomethine, azocondensation, metal-complex azo/azomethine, naphthol, metal (copper) phthalocyanines and dioxazine pigments.

The pigment, used in this process may or may not be surface treated, e.g. using treatments normally applied to pigments. The treatments may comprise additives which are natural or synthetic resins which may be in non-salt form or in salt form.

Examples of such resins include rosin, the principal component of which is abietic acid; also modified rosin such as hydrogenated, dehydrogenated or disproportionated rosin, dimersed or polymerised rosin, partially esterified rosin, non-esterified or partially esterified maleic or phenolic modified rosin. Illustrative rosins include such commercially available materials as Staybelite® resin (hydrogenated rosin), Recoldis A® resin (disproportionated rosin) and Dymerex® resin (dimerised rosin). The additive may also be an amine, e.g. Rosin Amine D® (dehydroabietyl amine). Amines can be used in radical curable systems as synergists for the photoinitiator, but should be avoided in cationic systems (neutralization of the initiating proton acid).

Additional to this water-soluble salt additive it is also optional that a non-polar component be present (U.S. Pat. No. 5,366,546 and U.S. Pat. No. 6,007,612).

Non-polar components, which may be added to the polar pigment additive may be, but are not limited to, rosin-modified phenolic resins, rosin-modified maleic resins, hydrocarbon resins, alkyd resins, phenolic resins, fatty alcohols, drying, semi-drying or non-drying oils, polyolefins, waxes, litho varnishes, or gloss varnishes, esters of abietic resins.

Other additives which may be incorporated in the pigment are e.g. materials which modify the crystal growth or improve dispersion of the pigment.

The dry granular pigment used in the present invention is preferably a low dusting meterable material with a mean size of 0.1 to 50 mm, but more preferably of 0.1 to 20 mm. Also the term dry is understood to refer to 0-5.0% moisture but more normally 0-2.0% residual moisture. The granules herein disclosed are conveniently prepared by a range of known methods and include as examples wet granulation using a extruder granulator followed by conventional drying of the granular extrudate, spray drying (U.S. Pat. No. 3,843,380), in-vat granulation (U.S. Pat. No. 4,255,375) or fluid-bed granulation (GB 2,036,057).

The organic carrier vehicles (radiation curable, e.g. uv-curable vehicles) into which the pigment granules/powder are dispersed may be any radiation polymerizable material consisting of ethylenically unsaturated compounds.

The unsaturated compounds may contain one or more olefinic double bonds. They may be of low (monomeric) or relatively high (oligomeric) molecular weight. Examples of monomers containing a double bond are alkyl or hydroxyalkyl acrylates or methacrylates, such as methyl, ethyl, butyl, 2-ethylhexyl or 2-hydroxyethyl acrylate, isobornyl acrylate, methyl methacrylate or ethyl methacrylate. Other examples are acrylonitrile, acrylamide, methacrylamide, N-substituted (meth)acrylamides, vinyl esters such as vinyl acetate, vinyl ethers such as isobutyl vinyl ether, styrene, alkylstyrenes and halostyrenes, N-vinylpyrrolidone, vinyl chloride or vinylidene chloride.

Examples of monomers containing two or more double bonds are ethylene glycol, propylene glycol, neopentyl glycol, hexamethylene glycol and Bisphenol-A diacrylates, 4,4′-bis(2-acryl-oyloxyethoxy)diphenylpropane, trimethylolpropane triacrylate, pentaerythritol triacrylate or tetraacrylate, vinyl acrylate, divinylbenzene, divinyl succinate, diallyl phthalate, triallyl phosphate, triallyl isocyanurate or tris(2-acryloylethyl)isocyanurate.

Examples of relatively high molecular weight (oligomeric) polyunsaturated compounds are acrylated epoxy resin and acrylated or vinyl ether- or epoxy-functional polyesters, polyurethanes and polyethers. Further examples of unsaturated oligomers are unsaturated polyester resins, generally prepared from maleic acid, phthalic acid and one or more diols and having molecular weights of from about 500 to 3000. In addition to these it is also possible to use vinyl ether monomers and oligomers, and also maleate-terminated oligomers with polyesters, polyurethane, polyether, polyvinyl ether and epoxide main chains. Especially suitable are combinations of polymers and oligomers which carry vinyl ether groups, as described in WO 90/01512. Also suitable, however, are copolymers of monomers functionalized with maleic acid and vinyl ether.

Also suitable are compounds containing one or more free-radically polymerizable double bonds. In these compounds the free-radically polymerizable double bonds are preferably in the form of (meth)acryloyl groups. (Meth)acryloyl and, respectively, (meth)acrylic here and below means acryloyl and/or methacryloyl, and acrylic and/or methacrylic, respectively. Preferably, at least two polymerizable double bonds are present in the molecule in the form of (meth)acryloyl groups. The compounds in question may comprise, for example, (meth)acryloyl-functional oligomeric and/or polymeric compounds of poly(meth) acrylate. The number-average molecular mass of this compound may be for example from 300 to 10 000, preferably from 800 to 10 000. The compounds preferably containing free-radically polymerizable double bonds in the form of (meth)acryloyl groups may be obtained by customary methods, for example by reacting poly(meth)acrylates with (meth)acrylic acid. These and other preparation methods are described in the literature and are known to the person skilled in the art.

Unsaturated oligomers of this kind may also be referred to as prepolymers.

Functionalized acrylates are also suitable. Examples of suitable monomers which are normally used to form the backbone (the base polymer) of such functionalized acrylate and methacrylate polymers are acrylate, methyl acrylate, methyl methacrylate, ethyl acrylate, ethyl methacrylate, n-butyl acrylate, n-butyl methacrylate, isobutyl acrylate, isobutyl methacrylate, 2-ethylhexyl acrylate, 2-ethylhexyl methacrylate etc. Additionally, appropriate amounts of functional monomers are copolymerized during the polymerization in order to give the functional polymers. Acid-functionalized acrylate or methacrylate polymers are obtained using acid-functional monomers such as acrylic acid and methacrylic acid. Hydroxy-functional acrylate or methacrylate polymers are formed from hydroxy-functional monomers, such as 2-hydroxyethyl methacrylate, 2-hydroxypropyl methacrylate and 3,4-dihydroxybutyl methacrylate. Epoxy-functionalized acrylate or methacrylate polymers are obtained using epoxy-functional monomers such as glycidyl methacrylate, 2,3-epoxybutyl methacrylate, 3,4-epoxybutyl methacrylate, 2,3-epoxycyclohexyl methacrylate, 10,11-epoxyundecyl methacrylate etc. Similarly, for example, isocyanate-functionalized polymers may be prepared from isocyanate-functionalized monomers, such as meta-isopropenyl-α,α-dimethylbenzyl isocyanate, for example.

Particularly suitable compounds are, for example, esters of ethylenically unsaturated monofunctional or polyfunctional carboxylic acids, polyols or polyepoxides, and polymers containing ethylenically unsaturated groups in the chain or in side groups, such as unsaturated polyesters, polyamides and polyurethanes and copolymers thereof, alkyd resins, polybutadiene and butadiene copolymers, polyisoprene and isoprene copolymers, polymers and copolymers containing (meth)acrylic groups in side chains, and also mixtures of one or more such polymers.

Examples of suitable monofunctional or polyfunctional unsaturated carboxylic acids are acrylic acid, methacrylic acid, crotonic acid, itaconic acid, cinnamic acid, maleic acid, fumaric acid, unsaturated fatty acids such as linolenic acid or oleic acid. Acrylic acid and methacrylic acid are preferred.

It is, however, also possible to use saturated dicarboxylic or polycarboxylic acids in a mixture with unsaturated carboxylic acids. Examples of suitable saturated dicarboxylic or polycarboxylic acids include tetrachlorophthalic acid, tetrabromophthalic acid, phthalic acid, trimellitic acid, heptanedicarboxylic acid, sebacic acid, dodecanedicarboxylic acid, or hexahydrophthalic acid.

Suitable polyols include aromatic and especially aliphatic and cycloaliphatic polyols. Examples of aromatic polyols are hydroquinone, 4,4′-dihydroxybiphenyl, 2,2-di(4-hydroxyphenyl)propane, and also novolaks and resols. Examples of polyepoxides are those based on the aforementioned polyols, especially the aromatic polyols, and epichlorohydrin. Further suitable polyols include polymers and copolymers containing hydroxyl groups in the polymer chain or in side groups, such as polyvinyl alcohol and copolymers thereof or polyhydroxyalkyl methacrylates or copolymers thereof, for example. Oligoesters containing hydroxyl end groups are further suitable polyols.

Examples of aliphatic and cycloaliphatic polyols are alkylenediols having preferably from 2 to 12 carbon atoms, such as ethylene glycol, 1,2- or 1,3-propanediol, 1,2-, 1,3- or 1,4-butanediol, pentanediol, hexanediol, octanediol, dodecanediol, diethylene glycol, triethylene glycol, polyethylene glycols having molecular weights of preferably from 200 to 1500, 1,3-cyclopentanediol, 1,2-, 1,3- or 1,4-cyclohexanediol, 1,4-dihydroxymethylcyclohexane, glycerol, tris-(β-hydroxyethyl)-amine, trimethylolethane, trimethylolpropane, pentaerythritol, dipentaerythritol and sorbitol.

The polyols may have been partly or fully esterified with one or more different unsaturated carboxylic acids, the free hydroxyl groups in partial esters possibly having been modified, e.g. etherified or esterified with other carboxylic acids.

Examples of esters are:

trimethylolpropane triacrylate, trimethylolethane triacrylate, trimethylolpropane trimethacrylate, trimethylolethane trimethacrylate, tetramethylene glycol dimethacrylate, triethylene glycol dimethacrylate, tetraethylene glycol diacrylate, pentaerythritol diacrylate, pentaerythritol triacrylate, pentaerythritol tetraacrylate, dipentaerythritol diacrylate, dipentaerythritol triacrylate, dipentaerythritol tetraacrylate, dipentaerythritol pentaacrylate, dipentaerythritol hexaacrylate, tripentaerythritol octaacrylate, pentaerythritol dimethacrylate, pentaerythritol trimethacrylate, dipentaerythritol dimethacrylate, dipentaerythritol tetramethacrylate, tripentaerythritol octamethacrylate, pentaerythritol diitaconate, dipentaerythritol trisitaconate, dipentaerythritol pentaitaconate, dipentaerythritol hexaitaconate, ethylene glycol diacrylate, 1,3-butanediol diacrylate, 1,3-butanediol dimethacrylate, 1,4-butanediol diitaconate, sorbitol triacrylate, sorbitol tetraacrylate, modified pentaerythritol triacrylate, sorbitol tetramethacrylate, sorbitol pentaacrylate, sorbitol hexaacrylate, oligoester acrylates and methacrylates, glycerol diacrylate and triacrylate, 1,4-cyclohexane diacrylate, bisacrylates and bismethacrylates of polyethylene glycol having a molecular weight from 200 to 1500, or mixtures thereof.

Furthermore, the following esters are suitable:

dipropylenglycol diacrylate, tripropylenglycol diacrylate, 1,6-hexandiol diacrylate, ethoxylated glycerol triacrylate, propoxylated glycerol triacrylate, ethoxylated trimethylolpropane triacrylate, propoxylated trimethylolpropane triacrylate, ethoxylated pentaerythritol tetraacrylate, propoxylated pentaerythritol triacrylate, propoxylated pentaerythritol tetraacrylate, ethoxylated neopentylglycol diacrylate, propoxylated neopentylglycol diacrylate.

Suitable components also include the amides of identical or different unsaturated carboxylic acids with aromatic, cycloaliphatic and aliphatic polyamines having preferably from 2 to 6, particularly from 2 to 4 amino groups. Examples of such polyamines are ethylenediamine, 1,2- or 1,3-propylenediamine, 1,2-, 1,3- or 1,4-butylenediamine, 1,5-pentylenediamine, 1,6-hexylenediamine, octylenediamine, dodecylenediamine, 1,4-diaminocyclohexane, isophoronediamine, phenylenediamine, bisphenylenediamine, di-β-aminoethyl ether, diethylenetriamine, triethylenetetramine, di-(β-aminoethoxy)- or di-(β-aminopropoxy)-ethane. Further suitable polyamines are polymers and copolymers containing possibly additional amino groups in the side chain, and oligoamides having amino end groups. Examples of such unsaturated amides are: methylenebisacrylamide, 1,6-hexamethylenebisacrylamide, diethylenetriaminetrismethacrylamide, bis(methacrylamidopropoxy)ethane, β-methacrylamidoethyl methacrylate, and N-[(β-hydroxyethoxy)ethyl]acrylamide.

Suitable unsaturated polyesters and polyamides are derived, for example, from maleic acid and diols or diamines. The maleic acid may have been replaced in part by other dicarboxylic acids. They may be used together with ethylenically unsaturated comonomers, e.g. styrene. The polyesters and polyamides may also be derived from dicarboxylic acids and ethylenically unsaturated diols or diamines, especially from relatively long chain ones having, for example, from 6 to 20 carbon atoms. Examples of polyurethanes are those synthesized from saturated or unsaturated diisocyanates and unsaturated or saturated diols, respectively.

Polybutadiene and polyisoprene and copolymers thereof are known. Examples of suitable comonomers are olefins such as ethylene, propene, butene, hexene, (meth)acrylates, acrylonitrile, styrene or vinyl chloride. Polymers containing (meth)acrylate groups in the side chain are likewise known. They may comprise, for example, reaction products of novolak-based epoxy resins with (meth)acrylic acid, homopolymers or copolymers of vinyl alcohol or the hydroxyalkyl derivatives thereof that have been esterified with (meth)acrylic acid, or homopolymers and copolymers of (meth)acrylates esterified with hydroxyalkyl (meth)acrylates.

The processing time for preparing the inventive radiation curable concentrates (obtained by dispersing the pigments in the form of granules or powder in the organic carrier vehicle which is said radiation polymerizable/curable material consisting of ethylenically unsaturated compound) is significantly reduced compared to conventional processes: due to the good compatibility between the dry pigment and the radiation polymerizable material compositions (concentrates) of high dispersibility are obtained which make them very suitable for the preparation of said radiation curable paints and inks as well as protective coatings.

They can be used alone or with the photoinitiators as mentioned hereinbelow, and further with additives, such as fillers, opacifiers, lubricants, plasticisers, natural or synthetic resins (as mentioned) or other modifying bodies. Preferably the compositions described do not contain a significant amount of any additive which is not chemically bondable with the radiation curable (polymerizable) material.

Sources of radiant energy appropriate for initiating polymerization/cure of the compositions are described in the literature and are well known to those skilled in the art. Especially useful is actinic radiation in the range of 180 to 440 nm which can be conveniently obtained by use of commercially available ultraviolet sources specifically intended for this purpose. These include low, medium and high pressure mercury vapor lamps, He—Cd and Ar lasers, xenon arc lamps and others.

The photoinitiator systems having a corresponding sensitivity to light in this wave band—when incorporated into said compositions—lead upon irradiation to the formation of reactive species capable of initiating a free radical polymerization.

Similarly, free radical polymerization may be induced by exposure of said composition to an electron beam without the use of a photoinitiator. Equipment capable of generating a curtain of electrons with energies in the 150-300 KeV range is particularly suitable for this purpose and its use is well documented in the literature.

Photoinitiators suitable for use in the process according to the invention are in principle any compounds and mixtures that form one or more free radicals when irradiated with electro-magnetic waves. These include initiator systems consisting of a plurality of initiators and systems that function independently of one another or synergistically. In addition to coinitiators, for example amines, thiols, borates, enolates, phosphines, carboxylates and imidazoles, it is also possible to use sensitisers, for example acridines, xanthenes, thiazenes, coumarins, thioxanthones, triazines and dyes. A description of such compounds and initiator systems can be found e.g. in Crivello J. V., Dietliker K. K., (1999): Chemistry & Technology of UV & EB Formulation for Coatings, Inks & Paints, and in Bradley G. (ed.) Vol. 3: Photo-initiators for Free Radical and Cationic Polymerisation 2nd Edition, John Wiley & Son Ltd. Such compounds and derivatives are derived, for example, from the following classes of compounds: benzoins, benzil ketals, benzophenones, acetophenones, hydroxyalkylphenones, aminoalkylphenones, acylphosphine oxides, bisacylphosphine oxides, acylphosphine sulfides, bisacylphosphine sulfides acyloxyiminoketones, alkylamino-substituted ketones, such as Michler's ketone, peroxy compounds, dinitrile compounds, halogenated acetophenones, phenylglyoxylates, dimeric phenylglyoxalates, oximes and oxime esters, thioxanthones, coumarins, ferrocenes, titanocenes, onium salts, sulfonium salts, iodonium salts, diazonium salts, borates, triazines, bisimidazoles, polysilanes and dyes. It is also possible to use combinations of the compounds from the mentioned classes of compounds with one another and combinations with corresponding coinitiator systems and/or sensitisers.

Preferred photoinitators are compounds selected from the group consisting of acetophenones, benzophenones, hydroxyalkylphenones, aminoalkylphenones, acylphoshine oxides and phenylglyoxylates, or mixtures thereof.

Suitable photoinitiators are compounds of the following formulae I to VI and/or VII: 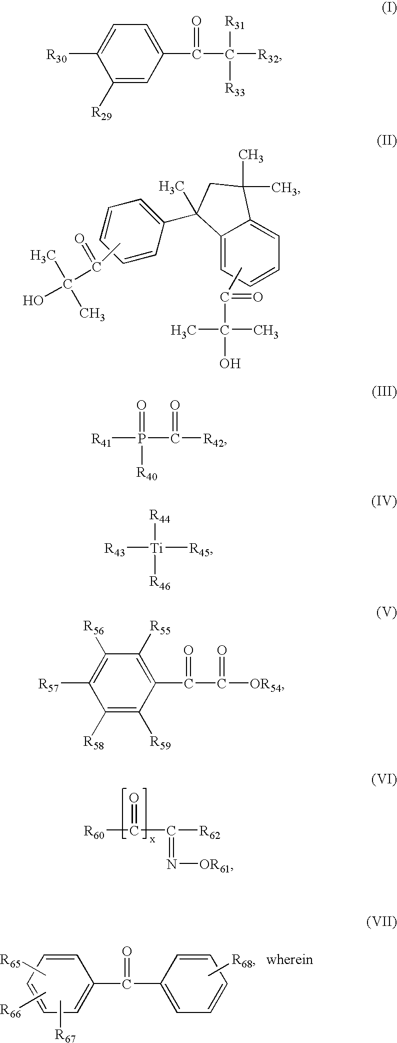
R₂₉ is hydrogen or C₁-C₁₈-alkoxy;
R₃₀ is hydrogen, C₁-C₁₈-alkyl, C₁-C₁₈-alkoxy, —OCH₂CH₂—OR₄₇, morpholino, SCH₃, a group —HC═CH—, 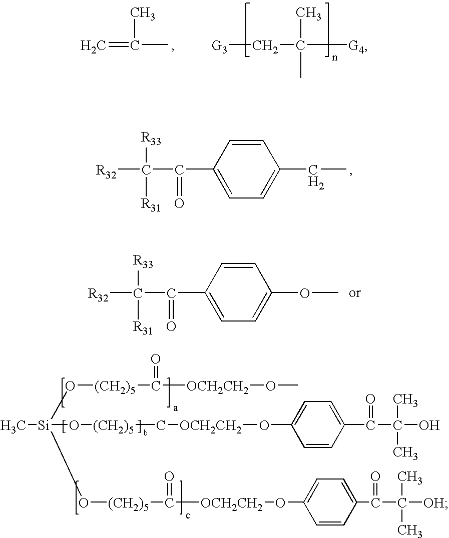
   a, b and C are b to 3;
   n is an integer 2 to 10;
   G₃ and G₄ independently of one another are end groups of a polymeric structure, preferably hydrogen or CH₃;
   R₃₁ is hydroxy, C₁-C₁₆-alkoxy, morpholino, dimethylamino or —O(CH₂CH₂O)ₘ—C₁-C₆-alkyl;
   R₃₂ and R₃₃ independently of one another are hydrogen, C₁-C₆-alkyl, C₁-C₁₆-alkoxy or —O(CH₂CH₂O)ₘ—C₁-C₁₆-alkyl; or R₃₂ and R₃₃ are phenyl or benzyl, said groups being unsubstituted or substituted by C₁-C₁₂-alkyl; or R₃₂ and R₃₃ together with the carbon atom to which they are bonded form a cyclohexyl ring;
   m is an integer 1 to 20;
   with the proviso that R₃₁, R₃₂ and R₃₃ not altogether are C₁-C₁₆-alkoxy or —O(CH₂CH₂O)ₘ—C₁-C₁₆-alkyl;
   R₄₇ is hydrogen, 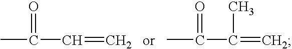
   R₄₀ and R₄₁ independently of one another are C₁-C₂₀-alkyl, cyclohexyl, cyclopentyl, phenyl, naphthyl or biphenylyl, wherein said radicals are unsubstituted or substituted by halogen, C₁-C₁₂-alkyl, C₁-C₁₂-alkoxy, C₁-C₁₂alkylthio or NR₅₂R₅₃, or R₄₀ and R₄₁ are independently of one another —(CO)R₄₂;
   R₄₂ is unsubstituted cyclohexyl, cyclopentyl, phenyl, naphthyl or biphenylyl, or cyclohexyl, cyclopentyl, phenyl, naphthyl or biphenylyl substituted by halogen, C₁-C₄-alkyl or/and/or C₁-C₄-alkoxy, or R₄₂ is an S- or N-containing 5- or 6-membered heterocyclic ring;
   R₄₃ and R₄₄ independently of one another are cyclopentadienyl optionally mono-, di- or tri-substituted by C₁-C₁₈-alkyl, C₁-C₁₈-alkoxy, cyclopentyl, cyclohexyl or halogen;
   R₄₅ and R₄₆ independently of one another are phenyl, which in at least one of the two ortho positions of the titan-carbon bond is substituted by fluoro atoms or CF₃ and which optionally contains pyrrolinyl or polyoxaalkyl at the aromatic ring as further substitutents, wherein said pyrrolinyl and polyoxaalkyl are unsubstituted or are substituted by one or two C₁-C₁₂-alkyl, di(C₁-C₁₂-alkyl)aminomethyl, morpholinomethyl, C₂-C₄-alkenyl, methoxymethyl, ethoxymethyl, trimethylsilyl, formyl, methoxy or phenyl,
   or R₄₅ and R₄₆ are 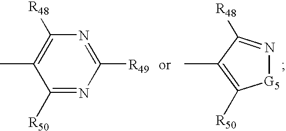
   R₄₈, R₄₉ and R₅₀ independently of each other are hydrogen, halogen, C₂-C₁₂-alkenyl, C₁-C₁₂alkoxy, C₂-C₁₂-alkoxy, interrupted by one to four O-atoms; cyclohexyloxy, cyclopentyloxy, phenoxy, benzyloxy, unsubstituted phenyl or biphenylyl, or phenyl or biphenylyl substituted by C₁-C₄-alkoxy, halogen, phenylthio or C₁-C₄-alkylthio,
   with the proviso that R₄₈ and R₅₀ are not both hydrogen and that with respect to residue 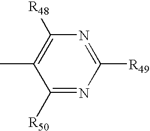
   at least one radical R₄₈ or R₅₀ is C₁-C₁₂alkoxy, C₂-C₁₂-alkoxy, interrupted by one to four oxygen atoms; cyclohexyloxy, cyclopentyloxy, phenoxy, benzyloxy;
   G₅ is O, S or NR₅₁;
   R₅₁ is C₁-C₈-alkyl, phenyl or cyclohexyl;
   R₅₂ and R₅₃ independently of one another are hydrogen; C₁-C₁₂-alkyl, or C₁-C₁₂-alkyl substituted by OH or SH whereby the alkyl chain may be interrupted by one to four oxygenatoms; or R₅₂ and R₅₃ are C₂-C₁₂-alkenyl, cyclopentyl, cyclohexyl, benzyl or phenyl;
   R₅₄ is hydrogen, C₁-C₁₂-alkyl or a group 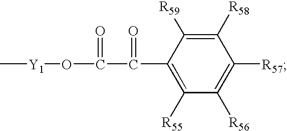
   R₅₅, R₅₆, R₅₇, R₅₈ and R₅₉ independently of each other are hydrogen; C₁-C₁₂-alkyl, which is unsubstituted or is substituted by OH, C₁-C₄-alkoxy, phenyl, naphthyl, halogen or CN and whereby the alkyl chain may be interrupted by one or more oxygen atoms; or R₅₅, R₅₆, R₅₇, R₅₈ and R₅₉ are C₁-C₄-alkoxy, C₁-C₄-alkythio or NR₅₂R₅₃;
   Y₁ is C₁-C₁₂-alkylene optionally interrupted by one or more oxygen atoms;
   x is 0 or 1;
   R₆₀ is phenyl, naphthyl, or, if x is 0, 9H-carbazol-3-yl, or (9-oxo-9H-thioxanthen-2-yl)-, wherein all said radicals are unsubstituted or are substituted by one or more SR₆₃, OR₆₄, NR₅₂R₅₃, halogen, C₁-C₁₂-alkyl, phenyl, benzyl, —(CO)—C₁-C₄-alkyl, —CO)-phenyl or —(CO)-phenylene-C₁-C₄-alkyl;
   R₆₁ is C₄-C₉-cycloalkanoyl; unsubstituted C₁-C₁₂-alkanoyl or C₁-C₁₂-alkanoyl substituted by one or more halogen, phenyl or CN; or R₆₁ is C₄-C₆-Alkenoyl, provided that, the double bond is not conjugated with the carbonyl group; or R₆₁ is unsubstituted nezoyl or is benzoyl substituted by one or more C₁-C₆-alkyl, halogen, CN, OR₆₄, SR₆₃ or NR₅₂R₅₃; or R₆₁ is C₂-C₆-alkoxycarbonyl, benzyloxycarbonyl; or unsubstituted phenoxycarbonyl or phenoxycarbonyl substituted by one or more C₁-C₆-alkyl or halogen;
   R₆₂ is hydrogen, phenyl or benzoyl, wherein the radicals phenyl and benzoyl are unsubstituted or are substituted by C₁-C₆-alkyl, phenyl, halogen, OR₆₄, SR₆₃ or NR₅₂R₅₃; or R₆₂ is C₁-C₂₀-alkyl or C₂-C₁₂-alkoxycarbonyl, wherein the radicals C₁-C₂₀-alkyl and C₂-C₁₂-alkoxycarbonyl are unsubstituted or are substituted by OH and optionally are interrupted by one or more O-atoms; or R₆₂ is C₂-C₂₀-alkanoyl, benzyl, benzyl-(CO)—, C₁-C₆-alkyl-SO₂— or phenyl-SO₂—;
   R₆₃ and R₆₄ independently of each other are hydrogen or unsubstituted C₁-C₁₂-alkyl or C₁-C₁₂-alkyl substituted by OH, SH, CN, phenyl, (CO)O—C₁-C₄-alkyl, O(CO)—C₁-C₄-alkyl, COOH, O(CO)-phenyl, wherein said unsubstituted or substituted C₁-C₁₂-alkyl optionally is interrupted by one or more O-atoms; or R₈₃ and R₆₄ are cyclohexyl or unsubstituted phenyl or phenyl substituted by C₁-C₁₂-alkyl, C₁-C₁₂-alkoxy or halogen, or R₆₃ and R₆₄ are phenyl-C₁-C₃-alkyl;
   R₆₅, R₆₈ and R₆₇ independently of one another other are hydrogen, C₁-C₄alkyl, C₁-C₄halogenoalkyl, C₁-C₄-alkoxy, chloro or —N(C₁-C₄-Alkyl)₂;
   R₆₈ is hydrogen, C₁-C₄alkyl, C₁-C₄halogenoalkyl, phenyl, N(C₁-C₄-Alkyl)₂, COOCH₃, 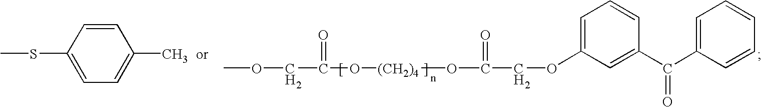
   with n being 2-10.

It is clear that the photoinitiators can be used single or in any desired mixture.

Preferred compounds of the formulae I, II, III, IV, V, VI and VII are α-hydroxycyclohexyl-phenyl-ketone or 2-hydroxy-2-methyl-1-phenyl-propanone, 2-hydroxy-2-methyl-1-[4-(4-(2-hydroxy-2-methyl-propano-1-yl)benzyl)phenyl]-propanone, (4-methylthiobenzoyl)-1-methyl-1-morpholino-ethane, (4-morpholino-benzoyl)-1-benzyl-1-dimethylamino-propane, (4-morpholino-benzoyl)-1-(4-methylbenzyl)-1-dimethylamino-propane, (3,4-dimethoxy-benzoyl)-1-benzyl-dimethylamino-propane, benzildimethylketal, (2,4,6-trimethylbenzoyl)-diphenyl-phosphinoxid, bis(2,6-dimethoxybenzoyl)-(2,4,4-trimethyl-pent-1-yl)phosphinoxid, bis(2,4,6-trimethylbenzoylyphenyl-phosphinoxid or bis(2,4,6-trimethylbenzoyl)(2,4-dipentoxyphenyl)phosphinoxid, 5,5′-oxodi(ethylenoxydicarbonylphenyl) and dicyclopentadienyl-bis(2,6-difluoro-3-pyrrolo)titan, as well as benzophenone, 4-phenylbenzophenone, 4-phenyl-3′-methylbenzophenone, 4-phenyl-2′,4′,6′-trimethylbenzophenone, 4-methoxybenzophenone, 4,4′-dimethoxybenzophenone, 4,4′-dimethylbenzophenone, 4,4′-dichlorobenzophenone, 4,4′-dimethylaminobenzophenone, 4,4′-diethylaminobenzophenone, 4-methylbenzophenone, 2,4,6-trimethylbenzophenone, 4-(4-methylthiophenylibenzophenone, 3,3′-dimethyl-4-methoxybenzophenone, methyl-2-benzoylbenzoat, 4-(2-hydroxyethylthio)-benzophenone, 4-(4-tolylthio)benzophenon, 4-benzoyl-N,N,N-trimethylbenzolmethanaminiumchloride, 2-hydroxy-3-(4-benzoylphenoxy)-N,N,N-trimethyl-1-propanaminiumchloride monohydrate, 4-(13-acryloyl-1,4,7,10,13-pentaoxatridecyl)-benzophenone, 4-benzoyl-N,N-dimethyl-N-[2-(1-oxo-2-propenyl)oxy]ethyl-benzolmethanaminiumchloride; 2,2-dichloro-1-(4-phenoxyphenyl)-ethanone, 4,4′-bis(chloromethyl)-benzophenone, 4-methylbenzophenone, 2-methylbenzophenone, 3-methylbenzophenone, 4-chlorobenzophenone, 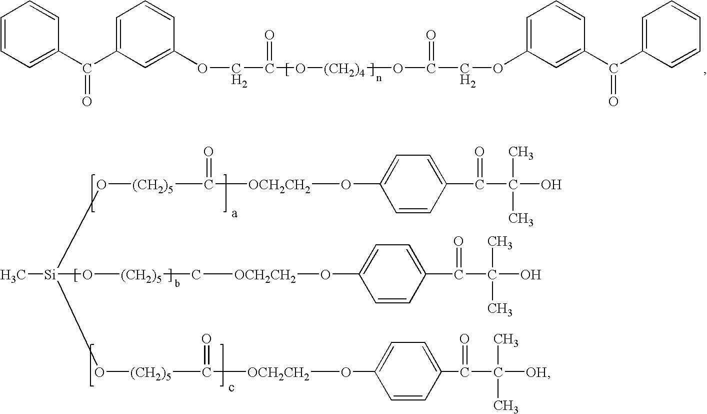
wherein a, b and c are an average value of 3 (SiMFPI2); as well as 2-chlorothioxanthone, 2,4-diethylthioxanthone, 2-isopropylthioxanthone, 3-isopropylthioxanthone, 1-chloro-4-propoxythioxanthone.

In preferred compounds of formula I R₃₂ and R₃₃ independently of one another are C₁-C₆-alkyl, or together with the carbon atom, to which they are bonded, form a cyclohexyl ring, and R₃₁ is hydroxyl.

Further preferred are compounds of formula III, wherein

R₄₀ is unsubstituted phenyl or is phenyl substituted by one to three C₁-C₁₂-alkyl or/and C₁-C₁₂-alkoxy or is C₁-C₁₂alkyl;

R₄₁ is (CO)R₄₂ or phenyl; and

R₄₂ is phenyl substituted by one to three C₁-C₄-alkyl or C₁-C₄-alkoxy.

The preparation of the compounds of formulae I, II, III, IV, V, VI and VII is known to the person skilled in the art and a host of said compounds is commercially available. The preparation of the oligomeric compounds of formula I is for example disclosed in EP 161463. A disclosure of the preparation of compounds of formula II is e.g. given in EP 209831. The preparation of compounds of the formula III is for example disclosed in EP 7508, EP 184095 and GB 2259704. The preparation of compounds of formula IV is for example known from EP 318894, EP 318893 and EP 565488. Compounds of the formula V are known from U.S. Pat. No. 6,048,660 and compounds of the formula VI from GB 2339571 or WO 02/100903.

Further of interest are so-called surface active photoinitiators, such as

surface active benzophenones (WO 02/48204);

surface active siloxane-modified hydroxyketones (EP 1,072,326); surface active benzil dialkyl ketals or benzoins (WO 02/48203);

surface active monomeric and dimeric arylglyoxalic acid esters modified with siloxane via an ester group (WO 02/14439);

surface active monomeric and dimeric arylglyoxalic acid esters modified with siloxane via an aromatic group (WO 02/14326);

surface active long-chain alkyl modified hydroxy-ketones (WO 02/48202).

The photopolymerizable compositions usually comprise the photoinitiator in an amount of 0.05 to 20% by weight, e.g. 0.05 to 15% by weight, in particular 0.1 to 5% by weight, based on the composition. This amount refers to the sum of all added photoinitiators, in case mixtures thereof are employed.

Particular photoinitators are:

a mixture of 2,4,6-trimethylbenzophenone and 4-methylbenzophenone (ESACURE TZT®); benzophenone;

1-Hydroxy-cyclohexyl-phenyl-ketone (IRGACURE® 184) or IRGACURE® 500 (a mixture of IRGACURE® 184 with benzophenone);

2-Methyl-1[4-(methylthio)phenyl]-2-morpholinopropan-1-one; (IRGACURE® 907)

2-Benzyl-2-dimethylamino-1-(4-morpholinophenyl)-butanone-1; (IRGACURE® 369)

1-[4-(2-Hydroxyethoxy)phenyl]-2-hydroxy-2-methyl 1-propane-1-one; (IRGACURE® 2959)

2,2-Dimethoxy-1,2-diphenylethan-1-one (IRGACURE® 651)

2-Hydroxy-2-methyl-1-phenyl-propan-1-one; (DAROCUR® 1173)

2-Dimethylamino-2-(4-methyl-benzyl)-1-(4-morpholin-4-yl-phenyl)-butan-1-one;

Benzyl-1-(3,4-dimethoxy-phenyl)-2-dimethylamino-butan-1-one;

2-Hydroxy-1-{4-[4-(2-hydroxy-2-methyl-propionyl)-benzyl]-phenyl}-2-methyl-propan-1-one;

2-Hydroxy-1-{4-[4-(2-hydroxy-2-methyl-propionyl)-benzyl]-phenyl}-2-methyl-propan-1-one;

2-Hydroxy-1-{4-[4-(2-hydroxy-2-methyl-propionyl)-phenoxy]-phenyl}-2-methyl-propan-1-one;

2-hydroxy-1-{1-[4-(2-hydroxy-2-methyl-propionyl)-phenyl]-1,3,3-trimethyl-indan-5-yl}-2-methyl-propan-1-one;

bis-(2,4,6-trimethylbenzoyl)-phenylphosphineoxide (IRGACURE® 819);

2,4,6-trimethylbenzoyl-diphenyl-phosphinoxide (DAROCUR® TPO);

bis-(2,6-dimethoxybenzoyl)-2,4,4-trimethyl pentylphosphineoxide;

bis-(eta.5-2,4-cylcopentadien-1-yl)-bis(2,6-difluoro-3-(1H-pyrrol-1-yl)-phenyl) titanium (IRGACURE® 784);

bis-(2,6-difluorophenyl)bis[(1,2,3,4,5-eta)-1-methyl-2,4-cyclopentadien-1-yl]-titanium (IRGACURE® 727)

oxo-phenyl-acetic acid 2-[2-(2-oxo-2-phenyl-acetoxy)-ethoxy]-ethyl ester.

The process for the manufacture of the dispersed pigment concentrates of the invention may use equipment currently used by manufacturers of coloured concentrates based on water containing pigmented feed-stocks, i.e. flush, and includes for example kneaders, extruders, high energy mixers but preferably kneaders of the Z-blade type or twin screw extruders.

The dispersed pigment concentrates so produced by this process have a pigment concentration ranging from 15-75%, but preferably from 20-60%.

The process of manufacture for example using conventional kneaders e.g. of the Z-blade type is most conveniently but not exclusively carried out by adding the appropriate amount of carrier, for example a printing ink varnish, mixing said varnish in the mixer, then metering in the appropriate quantity of pigment granules over a period of 1-20 minutes but more normally 2-5 minutes to produce a pulp of 40-80% pigment concentration but more ideally 50-65%. The granules rapidly wet out and are dispersed after 5-45 minutes but more often over 5-30 minutes. The resulting fully dispersed viscous pulp is then diluted by careful addition of carrier vehicle e.g. ink varnish and if required any other desired additives to the required pigmentation level of the final concentrate. The concentrate is then discharged for use in the appropriate application at the required pigmentation level.

The process of manufacture for example using a twin screw extruder is most conveniently, but not exclusively, carried out by metering the pigment into the extruder followed by injection of vehicle whereby the pigment is wetted out and dispersed under the conditions of high shear. Typical pigment concentration at this stage is 75-50%. Injection of further vehicle or component dilutes the concentrate to the desired concentration of pigment.

The pigment concentrates can be used by conventional methods for preparing radiation curing paint and ink systems as well as for preparing other coatings.

The final inks produced by employing the concentrates described above can be used in e.g. offset, flexo or gravure printing systems.

The pigmentation of the final inks, paints or other coating compositions is e.g. in a range of 3 to 25%, the amount of the photoinitiator being 0.1 to 10%, preferably 1 to 6%, and the rest being the uv-curable vehicles and other conventional additives.

The prints, paints and coatings obtained are of better, but at least of the same quality as those made from conventionally made concentrate or by conventional methods.

The performance enhancement of the cured pigmented inks/paints/coatings include e.g. good tinctorial strength and gloss, as well as advantageous mechanical properties such as surface hardness and good adhesion to substrate, and also chemical and corrosion resistance.

The invention is further illustrated by the following non-limiting examples. Parts and percentages are by weight, if not otherwise indicated.

### EXAMPLES

### Example 1

A pigment concentrate is prepared by dispersing the following components in a kneader:

35% Pigment Blue 15:3, C.I. No. 74'160; dry

46% Polyester acrylate (Ebecryl® 657)

15% dipropylene diacrylate (reactive diluent)

1% stabilizer

2% dispersant (Solsperse® 24000)

1% dispersant (Solsperse® 5000)

On the basis of this concentrate, a flexo ink is prepared showing the following composition:

52 parts of the concentrate

40 parts of ethoxylated pentaerythrythol tetracrylate (Ebecryl® 40)

8 parts of a photoinitiator (6 parts IRGACURE®369+2 parts IRGACURE® 184)

The print obtained with this ink exhibits improved colour strength and gloss, as well as advantageous mechanical properties and chemical resistance.

### Example 2

A uv-curable coating formulation containing

60% Polyester acrylate (Ebecryl® 830)

15% Hexandioldiacrylate

15% Trimethylolpropantriacrylate

10% pigment concentrate according to Example 1 is prepared in a kneader.

Then 1.5% of IRGACURE® 184 and 1.5% of IRGACURE® 819 are added and finely divided in the formulation.

The formulation is applied with a 100 μm slit coater on a white coil coat aluminium. The curing is carried out under 2 mercury medium pressure lamps with 2×120 W/cm at a belt speed of 3 m/min.

A well cured, homogenous film of good colour strength and gloss is obtained, showing further advantageous mechanical properties and also chemical and corrosion resistance.

### Example 3

### C.I. Pigment Blue 15.3 uv-Curable Concentrate

A uv-curable kneading vehicle is prepared by mixing the following components:

22% Ebecryl® 1608, 17% Ebecryl® 657, 37% Ebecryl® 150 and 24% Ebecryl® 220. 375 grams of this vehicle is then added to a Meili “Z” blade kneader. 375 grams of C.I. Pigment Blue 15.3 granules is then added over the period of 10 minutes. Kneading is carried out for a period of 3 hours, during this time a temperature of 60° C. is reached. The pigmentation is then reduced to 40% by adding 187.5 grams of the kneading vehicle and kneading continued for a further 1 hour. The resultant uv-concentrate is very soft and pliable.

The above concentrate is mixed on the back rolls of the Buhler SDY-200 three roll mill for 5 minutes at 40° C. The concentrate ink is then given 1×10 bar passes on the three roll mill. A final ink is then produced by reduction of the pigmentation to 14% this includes the addition of 21.4% IRGACURE® 907 photoinitiator by weight of the pigment in the final ink (about 3% of photoinitiator based on the whole ink composition).

Instead of IRGACURE®907 other photoinitiators such as IRGACURE® 184, 500, 369, 651, 819 or 2959, or mixtures thereof can be used.

The resultant final ink is printed in a conventional printing machine (Prüfbau printing machine) resulting in prints which are then cured using a conventional uv-source (SQP UV lab conveyor machine) by passing then twice at speed 10 on the conveyor; the uv-lamp being set on maximum power. The prints show excellent tinctorial strength and gloss, as well as advantageous mechanical properties and chemical resistance.

### Example 4

### C.I. Pigment Red 57.1 uv-Curable Concentrate

A uv-curable kneading vehicle is prepared by mixing the following components:

22% Ebecryl® 1608, 17% Ebecryl® 657, 37% Ebecryl® 150 and 24% Ebecryl® 220. 125 grams of this vehicle is then added to a “Z” blade kneader. 125 grams of C.I. Pigment Red 57.1 granules is then added over the period of 10 minutes. Kneading is carried out for a period of 1 hours, during this time a temperature of 73° C. is reached. The pigmentation is then reduced to 40% by adding 62.5 grams of the kneading vehicle and kneading continued for a further 10 minutes until homogenous. The resultant uv-concentrate is very soft and pliable.

The above concentrate is mixed on the back rolls of the Buhler SDY-200 three roll mill for 5 minutes at 40° C. The concentrate ink is then given 1×10 bar passes on the three roll mill. A final ink is then produced by reduction of the pigmentation to 14.5% this includes the addition of 20.7 IRGACURE® 907 photo initiator by weight of pigment in the final ink (about 3% of photoinitiator based on whole ink composition).

The resultant final ink is used and the prints are cured as shown in Example 3; the prints show excellent tinctorial strength and gloss, as well as advantageous mechanical properties and chemical resistance.

### Example 5

### C.I. Pigment Yellow 13 uv-Curable Concentrate

A uv-curable kneading vehicle is prepared by mixing the following components:

22% Ebecryl® 1608, 17% Ebecryl® 657, 37% Ebecryl® 150 and 24% Ebecryl® 220. 125 grams of this vehicle is then added to “Z” blade kneader. 125 grams of C.I. Pigment Yellow 13 granules is then added over the period of 10 minutes. Kneading is carried out for a period of 1 hour, during this time a temperature of 46° C. is reached. The pigmentation is then reduced to 40% by adding 62.5 grams of the kneading vehicle and kneading continued for a further 10 minutes until homogenous. The resultant uv-curable concentrate is very soft and pliable.

The above concentrate is mixed on the back rolls of the Bühler SDY-200 three roll mill for 5 minutes at 40° C. The concentrate ink is then given 1×10 bar passes on the three roll mill. A final ink is then produced by reduction of the pigmentation to 12% this includes the addition of 25% of IRGACURE 907 photo initiator by weight of pigment in the final ink (about 3% of photoinitiator based on the whole ink composition).

The resultant final ink is used and the prints are cured as shown in Example 3; the prints show excellent tinctorial strength and gloss, as well as advantageous mechanical properties and chemical resistance.

### Example 6

### C. l. Pigment Violet 23 uv-Curable Concentrate

A uv-curable kneading vehicle is prepared by mixing the following components:

22% Ebecryl® 1608, 17% Ebecryl® 657, 37% Ebecryl® 150 and 24% Ebecryl® 220. 125 grams of this vehicle is then added to a “Z” blade kneader. 125 grams of C.I. Pigment Violet 23 granules is then added over the period of 10 minutes. Kneading is carried out for a period of 1 hours, during this time a temperature of 75° C. is reached. The pigmentation is then reduced to 40% by adding 62.5 grams of the kneading vehicle and kneading continued for a further 10 minutes until homogenous. The resultant uv-curable concentrate is very soft and pliable.

The above concentrate is mixed on the back rolls of the Bühler SDY-200 three roll mill for 5 minutes at 40° C. The concentrate ink is then given 1×10 bar passes on the three roll mill. A final ink is then produced by reduction of the pigmentation to 14% this includes the addition of 21.4% of IRGACURE 907 photo initiator by weight of pigment in the final ink (about 3% of photoinitiator based on the whole ink composition).

The resultant final ink is used and the prints are cured as shown in Example 3; the prints show excellent tinctorial strength and gloss, as well as advantageous mechanical properties and chemical resistance.

### Example 7

### C.I. Pigment Blue 15:3 uv-Curable Concentrate by Extrusion

C.I. Pigment Blue 15:3 granules are continuously supplied to a co-rotating twin screw extruder (MP2040 type of APV Baker, Peterborough, UK) at a feed rate of 4 kg/h. A uv-curable extrusion vehicle is prepared by mixing the following components: 22% Ebecryl® 1608, 17% Ebecryl® 657, 37% Ebecryl® 150 and 24% Ebecryl® 220 and is continuously supplied as a liquid before the first extrusion mixing zone through one inlet at a rate of 6 kg/h. The resulting uv-curable concentrate has a pigmentary CuPc content of 40% by weight.

The above concentrate is mixed on the back rolls of the Buhler SDY-200 three roll mill for 5 minutes at 40° C. The concentrate ink is then given 1×10 bar passes on the three roll mill. A final ink is then produced by reduction of the pigmentation to 14% this includes the addition of 21.4% of IRGACURE 907 photo initiator by weight of pigment in the final ink (about 3% of photoinitiator based on the whole ink composition).

The resultant final ink is used and the prints are cured as shown in Example 3; the prints show excellent tinctorial strength and gloss, as well as advantageous mechanical properties and chemical resistance.

### Example 8

### C.I. Pigment Blue 15:3 uv-Curable Concentrate by Extrusion

C.I. Pigment Blue 15:3 granules are continuously supplied to a co-rotating twin screw extruder (MP2040 type of APV Baker, Peterborough, UK) at a feed rate of 4 kg/h. A uv-curable extrusion vehicle is prepared by mixing the following components: 22% Ebecryl® 1608, 17% Ebecryl® 657, 37% Ebecryl® 150 and 24% Ebecryl® 220 and is continuously supplied as a liquid before the first extrusion mixing zone through one inlet at a rate of 4 kg/h.

At this stage the pigment content of the uv-curable concentrate is 50% by weight. A second injection of identically composed uv-curable extrusion vehicle occurs through one inlet port at 2 kg/h, to reduce the pigmentation to 40% by weight.

The above concentrate is mixed on the back rolls of the Buhler SDY-200 three roll mill for 5 minutes at 40° C. The concentrate ink is then given 1×10 bar passes on the three roll mill. A final ink is then produced by reduction of the pigmentation to 14% this includes the addition of 21.4% of IRGACURE 907 photo initiator by weight of pigment in the final ink (about 3% of photoinitiator based on the whole ink composition).

The resultant final ink is used and the prints are cured as shown in Example 3; the prints show excellent tinctorial strength and gloss, as well as advantageous mechanical properties and chemical resistance.

1. A process for preparing pigment concentrates for use in radiation curable paints, inks and coatings which comprises dispersing a dry pigment in a radiation-curable composition.

2. A process according to claim 1 wherein the radiation curable composition comprises a dispersed organic pigment in a radiation polymerizable ethylenically-unsaturated compound and other conventional additives.

3. A process according to claim 1 wherein the pigment is selected from the group consisting of monoazo, disazo, azomethine, azocondensation, metal-complex azo/azomethine, naphthole, metal (copper) phthalocyanines and dioxazine pigments.

4. A process according to claim 1 wherein the dry pigment is in granular or powder form.

5. A process according to claim 2 wherein the radiation polymerizable ethylenically-unsaturated compound contains one or more olefinic double bonds and are of low (monomeric) or relatively high (oligomeric) molecular weight.

6. A process according to claim 5 in which the radiation polymerizable ethylenically-unsaturated compound comprises a compound selected from the group of esters of ethylenically unsaturated monofunctional or polyfunctional carboxylic acids and polyols or polyepoxides; unsaturated polyesters, polyamides and polyurethanes containing ethylenically unsaturated groups in the chain or in side groups and copolymers thereof; alkyd resins, polybutadiene and butadiene copolymers, polyisoprene and isoprene copolymers, polymers and copolymers containing (meth)acrylic groups in side chains or mixtures of one or more such polymers.

7. A process according to claim 2 wherein the conventional additives comprise plasticizers, dispersants, fillers, natural and/or synthetic resins.

8. A process according to claim 1 which is carried out in a kneader, a kneader/extruder, an extruder, or other dispersing equipment.

9. A dispersed pigment concentrate prepared according to the process of claim 1.

10. A pigment concentrate according to claim 9 which contains 15 to 75% by weight of pigment.

11. A radiation curable paint, printing ink, or coating composition, comprising the pigment concentrate according to claim 9.

12. Method of printing, painting or coating of the surface of a substrate which comprises a printing step or the painting or coating of the surface of a substrate with the radiation curable paint, printing ink or coating composition of claim 11, optionally containing a photoinitiator, and the exposure to a radiation source until a fixed print or an adherent dry cured film is formed on said surface of the substrate.

13. Method according to claim 12, wherein the composition, contain a photoinitiator and the exposure to radiation is carried out by a ultraviolet radiation source.

14. Method according to claim 12, wherein the composition is free from a photoinitiator and the exposure to radiation is carried out by an electron beam.

15. Method according to claim 13, wherein the composition contains a photoinitiator selected from the group consisting of acetophenones, benzophenones, hydroxyalkylphenones, aminoalkylphenones, acylphoshine oxides and phenylglyoxylates, or mixtures thereof.
